(19) United States
(12) Patent Application Publication
(10) Pub. No.: US 2019/0243217 A1
(43) Pub. Date: Aug. 8, 2019

(54) NOISELESS OMNIDIRECTIONAL CAMERA APPARATUS

(71) Applicant: CENTER FOR INTEGRATED SMART SENSORS FOUNDATION, Daejeon (KR)

(72) Inventors: Ki Yeong Park, Daejeon (KR); Kyung ll Cho, Daejeon (KR)

(21) Appl. No.: 16/265,161

(22) Filed: Feb. 1, 2019

(30) Foreign Application Priority Data
Feb. 2, 2018 (KR) 10-2018-0013292

(51) Int. Cl. G03B 17/55; G03B 37/04; H04N 13/243; H04N 13/156

(52) U.S. Cl. CPC G03B 17/55; H04N 13/156; H04N 13/243; G03B 37/04

(57) ABSTRACT

Disclosed is a noiseless omnidirectional camera apparatus. The noiseless omnidirectional camera apparatus includes a heat radiating structure, separated from a main body including a plurality of camera and a microphone, including at least one of a heat sink, a fan, a thermo-electric element, and a battery such that, without a noise and a vibration generated from the heat radiating structure affecting on a video quality, heats generated in the main body may be dissipated and cooled and a weight balance may be achieved for maintaining the main body at a level state.

### CROSS-REFERENCE TO RELATED APPLICATIONS

This application claims priority under 35 U.S.C. § 119 to Korean Patent Application No. 10-2018-0013292 filed on M D, Y, in the Korean Intellectual Property Office, the disclosures of which are incorporated by reference herein in their entireties.

### BACKGROUND

Embodiments of the inventive concept described herein relate to a noiseless omnidirectional camera apparatus, and more particularly, relate to a camera apparatus that includes a heat radiating structure, spaced apart from a main body, that dissipates heats generated from a plurality of cameras arranged in an omnidirectional manner, and achieves a weight balance between the main body and the heat radiating structure such that the main body including the plurality of cameras is maintained at a level state.

A 360 camera technology to film in an omnidirectional manner of 360 degrees using a plurality of camera modules has been increased recently. A 360 camera currently introduced in the market includes a 360 camera for a consumer and a 360 camera for a professional. The 360 camera for a consumer has a form of a combination of two fisheye lenses. On the other hand, dozens of camera modules may be used in the 360 camera for a professional. For example, a Facebook's Surround 360×24 is constituted by 24 camera modules, and a Yi Halo for Google Jump is constituted by of 17 camera modules.

Like this, the 360 camera must perform a stitching process for combining input images captured by the plurality of camera modules into one video. However, most 360 cameras for a professional do not perform the stitching for combining the input images of the plurality of camera modules into the single video in a real-time manner, but performs the stitching through a post process.

This stitching requires high performance CPU and GPU which release a lot of heat.

A parallax exists between the input images captured by the plurality of camera modules constituting the 360 camera. When the parallax is large, a seamless stitching may not be possible. In this connection, The larger the distance between the camera modules, the larger the parallax. Thus, the smaller the size (diameter) of the 360 camera, the better the stitching. The larger the diameter of the camera module, the more limited the short-range filming.

That is, the 360 camera may be expected to improve in terms of a resolution and a video quality as the number of camera modules included in the 360 camera increases. However, as the number of the camera modules increases, the power consumption and a heat generation increase.

In addition, the smaller the size (diameter) of the camera module included in the 360 camera, the better the stitching. However, when the size of the camera module is small, a ‘thermal density’ becomes high, and a cooling of the camera module may not be achieved sufficiently by a self-heating alone.

Therefore, the existing 360 camera uses a fan to reduce the heat generation. However, there is a problem that the fan mounted for reducing the heat generation may become a noise source when filming the video, and a vibration of the fan affects the video quality. Furthermore, when the camera module of the existing 360 camera is not cooled properly, a noise of an image sensor increases.

### PRIOR ART DOCUMENT

U.S. Pat. No. 9,036,001 (May 19, 2015), “IMAGING SYSTEM FOR IMMERSIVE SURVEILLANCE”

U.S. Pat. No. 9,615,011 (Apr. 4, 2017), “ELECTRONIC DEVICE WITH EFFICIENT THERMAL DISPOSITION”

### SUMMARY

Embodiments of the inventive concepts provide a camera apparatus that forms, by separating, a main body including a plurality of cameras and a microphone, and a heat radiating structure that radiates heats generated from the plurality of cameras such that the generated heats of the main body may be dissipated and cooled without a noise and a vibration generated in the heat radiating structure affecting a video quality.

In addition, embodiments of the inventive concepts provide a camera apparatus that forms, by separating from a main body, a heat radiating structure including at least one of a heat sink, a fan, a thermo-electric element, and a battery such that a weight balance is achieved for maintaining the main body at a level state.

According to one aspect, a noiseless omnidirectional camera apparatus may include a main body including a plurality of cameras for generating omnidirectional image data, a microphone for acquiring omnidirectional sound data, and a heat collecting module for collecting heats generated from the plurality of cameras, a heat radiating structure spaced apart from the main body, the heat radiating structure radiating the heats collected by the heat collecting module, and a connector for connecting the main body and the heat radiating structure, the connector transferring the heats collected by the heat collecting module to the heat radiating structure.

According to an exemplary embodiment, the heat radiating structure as a noise source or a vibration source may be spaced from the main body including the microphone for acquiring ambient sound data, such that the camera apparatus may generate noiseless video data.

According to an exemplary embodiment, the main body may include an image processing module for stitching the omnidirectional image data generated by the plurality of cameras to generate the video data.

According to an exemplary embodiment, the main body may include heat transfer modules for transferring, to the heat collecting module, respectively the heats generated from the plurality of cameras arranged at a predetermined interval.

According to an exemplary embodiment, the heat radiating structure may be spaced apart from the main body. The heat radiating structure may include at least one of a heat sink, a fan, a thermo-electric element, and a battery. The heat radiating structure may be further constructed for achieving a weight balance such that the main body is maintained at a level state.

According to an exemplary embodiment, the heat radiating structure may include a single heat radiating structure or a plurality of heat radiating structures.

According to an exemplary embodiment, the heat radiating structure may use the heat sink and the fan to dissipate the heats collected in the main body.

According to an exemplary embodiment, the heat radiating structure may use the heat sink and the thermo-electric element to cool the main body.

According to an exemplary embodiment, the connector may be in a form of a heat pipe, and may transfer the heats collected by the heat collecting module to the heat radiating structure.

According to an exemplary embodiment, the heat pipe may include a heat input portion for sucking the heats collected by the heat collecting module, an insulation portion for transferring the collected heat, and a heat output portion for discharging the collected heats to the heat radiating structure. The collected heats may move in and along an inner space defined in the pipe and the pipe may have a heat insulating coating on an outer face.

According to an exemplary embodiment, the noiseless omnidirectional camera apparatus may further include a balancing actuator coupled to the connector. The balancing actuator may allow the heat radiating structure to pivot around an axis such that the main body moves while being maintained at an upright state.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 shows a perspective view of a noiseless omnidirectional camera apparatus according to an embodiment of the inventive concept;

FIG. 2 is a cross-sectional view illustrating details of a noiseless omnidirectional camera apparatus according to an embodiment of the inventive concept;

FIG. 3 shows a detailed structure of a connector according to an embodiment of the inventive concept;

FIG. 4 shows an application example of a noiseless omnidirectional camera apparatus according to another embodiment of the inventive concept; and

FIGS. 5 and 6 show application examples of a noiseless omnidirectional camera apparatus according to another embodiment of the inventive concept.

### DETAILED DESCRIPTION

Hereinafter, embodiments according to the inventive concept will be described in detail with reference to the accompanying drawings. However, the inventive concept is not limited or restricted to embodiments. In addition, the same reference numerals shown in the drawings denote the same members.

In addition, the terminologies used in the specification are used for properly describing the preferred embodiments of the inventive concept. The terminologies may vary depending on an intention of an audience and an operator, or a practice of the field to which the inventive concept belongs. Thus, the definitions of the terminologies should be based on the contents throughout the specification.

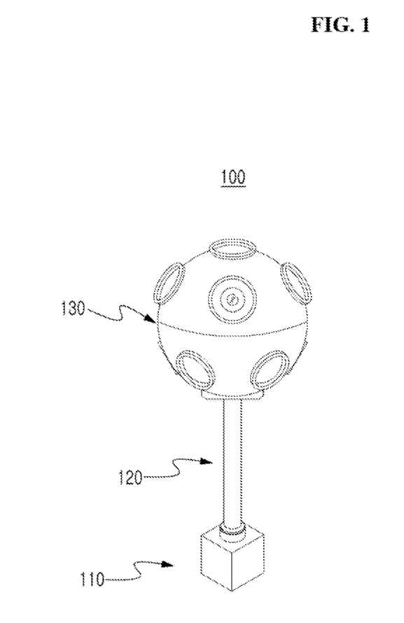

FIG. 1 shows a perspective view of a noiseless omnidirectional camera apparatus according to an embodiment of the inventive concept.

With reference to FIG. 1, a noiseless omnidirectional camera apparatus according to an embodiment of the inventive concept has a heat radiating structure, spaced apart from a main body, that radiates heats generated from a plurality of cameras arranged in an omnidirectional manner. The heat radiating structure achieves a weight balance between the main body and the heat radiating structure such that the main body including the plurality of cameras is maintained at a level state.

To this end, a noiseless omnidirectional camera apparatus 100 according to an embodiment of the inventive concept includes a heat radiating structure 110, a connector 120, and a main body 130.

The main body 130 includes a plurality of cameras for generating video data in omnidirectional manner (or 360 degrees), and a heat collecting module for collecting heats generated from the plurality of cameras.

The main body 130 may include the plurality of cameras arranged in a circular or spherical shape and a housing for fixing the plurality of cameras. In this case, each camera may have its own hardware specification or a preset angle of view. In this connection, the main body 130 includes the plurality of cameras arranged in the omnidirectional manner (360 degrees), but may include a plurality of cameras arranged in such a manner that some angles of view are restricted in a vertical direction or a horizontal direction. That is, an arrangement, an arrangement angle, and angles of view of the plurality of cameras in the main body 130 are only based on an application example, and not limited thereto.

In addition, the main body 130 may further include an image processing module (video signal processor, not shown). The image processing module may stitch the image data respectively generated from the plurality of cameras arranged in the omnidirectional manner to generate the video data. In this connection, the camera captures a subject, a background, an environment, and the like to acquire the video data, and a type, and the number thereof are not limited. In addition, the image processing module is located inside the main body 130 by default. However, the image processing module may be located in the heat radiating structure 110 in addition to the main body 130, or may be located externally of the camera apparatus 100.

Furthermore, the main body 130 may further include a heat collecting module for collecting the heats generated from the plurality of cameras, and heat transfer modules (not shown) for connecting the cameras and the heat collecting module.

The heat radiating structure 110 is spaced apart from the main body 130, and radiates the heats collected by the heat collecting module.

For example, the heat radiating structure 110 is for dissipating the heats generated in the main body 130 including the plurality of cameras into an atmosphere, and may include a heat sink, a fan, and the like. Further, the heat radiating structure 110 may include several components and circuits such as a thermo-electric element, a battery, and a main processor, for a weight distribution with the main body 130. With reference to FIG. 1, the heat radiating structure 110 is in a form of a cube, but is not limited thereto, and it is natural that the heat radiating structure 110 has various forms, shapes, sizes, and weights according to an embodiment to which the inventive concept is applied.

In addition, the noiseless omnidirectional camera apparatus 100 according to an embodiment of the inventive concept may include the plurality of heat radiating structures 110, as needed, to increase a heat radiation efficiency.

The connector 120 connects the main body 130 and the heat radiating structure 110, and conveys the heats collected by the heat collecting module to the heat radiating structure 110.

The connector 120 separates the main body 130 from the heat radiating structure 110, which may be a noise source and a vibration source, by a predetermined distance or more. The connector 120 may be in a form of a pipe for transmitting the heats generated in the main body 130 to the heat radiating structure 110. For example, the connector 120 may be in a form of a heat pipe including an inner space defined therein for moving the heats and an outer face coated with a heat insulating material.

Further, the noiseless omnidirectional camera apparatus 100 according to an embodiment of the inventive concept maintains a weight balance between the main body 130 and the heat radiating structure 110 about the connector 120 to maintain the main body 130 at a level state. In addition, the noiseless omnidirectional camera apparatus 100 according to an embodiment of the inventive concept generates noiseless video data by separating the main body 130 including a microphone for acquiring ambient sound data from the heat radiating structure 110 as the noise source or the vibration source.

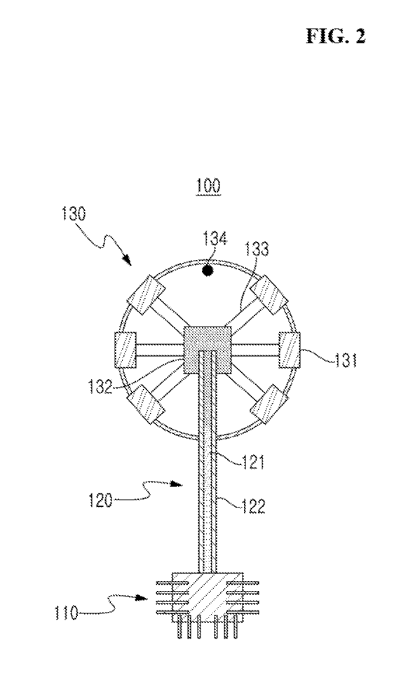

FIG. 2 is a cross-sectional view illustrating details of a noiseless omnidirectional camera apparatus according to an embodiment of the inventive concept.

When viewing a cross-sectional view of the noiseless omnidirectional camera apparatus 100 according to an embodiment of the inventive concept with reference to FIG. 2, the main body 130 includes a plurality of cameras 131 arranged in a predetermined interval in an omnidirectional manner and a heat collecting module 132 for collecting heats generated from the plurality of cameras 131.

Further, the main body 130 may include a plurality of heat transfer modules 133 respectively connected to the plurality of cameras 131, and transferring respectively the heats generated from the plurality of cameras 131 to the heat collecting module 132 and a microphone 134 for collecting sound data for generating video data. In this connection, a position and the number of the microphone 134 are not limited thereto, and the microphone 134 may be included in the camera 131.

The camera 131 may be an HD camera, an ultra-HD (UHD) camera, an image sensor, and the like for capturing an image, and may be arranged in a circular or spherical shape based on a shape of the housing, and may be arranged in an omnidirectional manner of 360 degrees by a predetermined angle or an interval.

The heat collecting module 132 may be located at a center or a lower portion of the main body 130. The heat collecting module 132 may collect the heats generated from the cameras 131 from the plurality of heat transfer modules 133 respectively connected to the plurality of cameras 131. In this connection, the heat transfer modules 133 may be in a form of an aluminum pipe for a rapid heat transfer, and the heat collecting module 132 may be made of a material for collecting the heats and may be in a form of a box or a sphere. However, materials, components, metal types, shapes, and forms of the heat collecting module 132 and the heat transfer modules 133 are not limited in a case when those are optimized for the heat transfer and the heat collection, do not affect a weight and a size of the main body 130, and are relatively inexpensive.

The heat radiating structure 110 is spaced apart from the main body 130, and may include at least one of the heat sink, the fan, the thermo-electric element, and a battery. The heat sink may be of a self-heating type. For example, the heat radiating structure 110 may dissipate the heats generated from the main body 130 using the heat sink and the fan, and may cool the main body 130 using the heat sink and the thermo-electric element (or a Peltier element).

Further, the heat radiating structure 110 may include several components such as the battery, a main processor and circuits to achieve the weight balance for maintaining the main body 130 at a level state. For example, the noiseless omnidirectional camera apparatus 100 according to an embodiment of the inventive concept may distribute a weight of the main body 130 using the heat radiating structure 110 having a predetermined weight, and may achieve the weight balance for maintaining the main body 130 at a level state.

The noiseless omnidirectional camera apparatus 100 according to an embodiment of the inventive concept may include the at least one heat radiating structure 110 to increase weight distribution and heat radiation performance.

That is, the noiseless omnidirectional camera apparatus 100 according to an embodiment of the inventive concept separates the heat radiating structure 110 including the heat sink and the fan from the main body 130 such that the noise and the vibration generated from the heat sink and the fan do not affect the microphone 134 of the main body 130. Further, the noiseless omnidirectional camera apparatus 100 separates the heat radiating structure 110 including at least one of the heat sink, the fan, the thermo-electric element, the battery, and the main processor from the main body 130 such that the heat radiating structure 110 distributes the weight of the main body 130 for maintaining the weight balance to maintain the main body 130 at a level state.

With reference to FIG. 2, the connector 120 may transfer the heats collected in heat collection module 132, which is transferred from the main body 130 to the heat radiating structure 110. In this connection, the connector 120 may be in the form of the heat pipe, and may include an inner space 121 defined therein for moving the collected heats and an outer surface 122 coated with a heat insulating material. For example, a user may utilize the connector 120 of the noiseless omnidirectional camera apparatus 100 as a handle. Thus, the outer surface 122 of the connector 120 may be coated with the heat insulating material such that the heats moving in and along the inner space 121 are not transmitted to a part of a user's body.

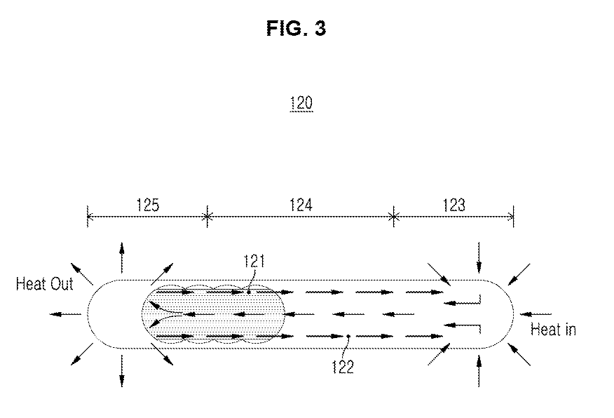

Hereinafter, a detailed structure of the connector 120 will be described in detail with reference to FIG. 3.

FIG. 3 shows a detailed structure of a connector according to an embodiment of the inventive concept.

With reference to FIG. 3, the connector 120 according to an embodiment of the inventive concept transfers the heats collected in the main body 130 to the heat radiating structure 110, and may be in the form of the heat pipe, for example. In this connection, the connector 120 may be constituted by a heat input portion 123 for sucking the collected heats, an insulation portion 124 for transferring the heats, and a heat output portion 125 for discharging the heats to the heat radiating structure 110. The connector 120 may include the inner space 121 defined therein for moving the heats and the outer surface coated with the heat insulating material.

The heat input portion 123 may be connected to the heat collecting module 132 of the main body 130, and may absorb the heats collected in the heat collecting module 132. For example, the heat input portion 123 may suck the heats collected in the heat collecting module 132 using a wick, or using an air pressure, but a method of suction is not limited.

The heats input to the heat input portion 123 and moving in and along the insulation portion 124 may be discharged through the heat output portion 125 to the heat radiating structure 110. The heat output portion 125 may be connected to the heat radiating structure 110, and may discharge the heats moving in and along the insulation portion 124 to the heat radiating structure 110.

As shown in FIG. 3, the connector 120 is in the form of the pipe, and the inner space 121 may be a space along which the heat or a gas resulting from the heat moves. In addition, the outer surface 122 may be a surface to which the part of the user's body may be contacted. Thus, the outer surface 122 may be coated with the heat insulating material to prevent the heat moving along the inner space 121 from being transmitted to the part of the user's body. In some embodiments, the connector 120 may be made of a material, a component, or a metal having a high heat transfer efficiency. In addition, materials, components, and metal types of the inner space 121 and the outer surface 122 may be different from each other, or may be the same.

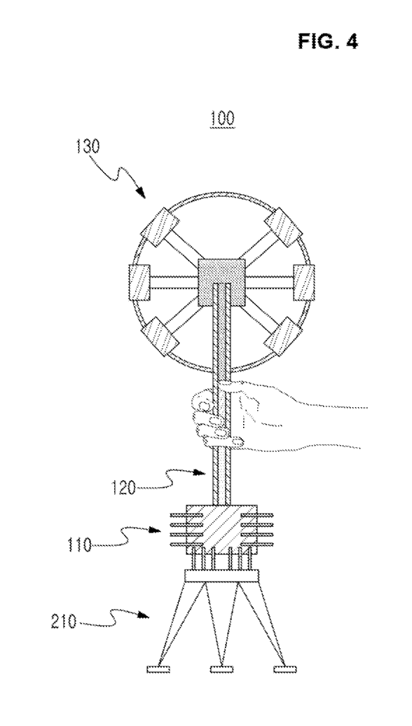

FIG. 4 shows an application example of a noiseless omnidirectional camera apparatus according to another embodiment of the inventive concept.

With reference to FIG. 4, the noiseless omnidirectional camera apparatus 100 according to another embodiment of the inventive concept may further include a tripod 210 coupled to the heat radiating structure 110. In this connection, the tripod 210 may be a support for supporting video equipment such as a camera, a smart phone, and the like. The tripod 210 is currently in common use, and a material, a shape, a composition, a form, the number of feet thereof, and the like are not limited.

The noiseless omnidirectional camera apparatus 100 according to another embodiment of the inventive concept may include a thermal docking structure between the heat radiating structure 110 and the tripod 210. Through this, the heats generated from the cameras of the main body 130 and collected may pass the connector 120 and the heat radiating structure 110, and may be dissipated through a heat sink of the self-heating type located at the tripod 210.

That is, the noiseless omnidirectional camera apparatus 100 according to another embodiment of the inventive concept may divide and separate the main body 130 including the microphone and the cameras and the tripod 210 including the heat sink. Thus, when the heats generated at the main body 130 is dissipated using the heat sink, an effect of the noise and the vibration that may be generated on a quality degradation of the video data to be processed in the main body 130 may be minimized.

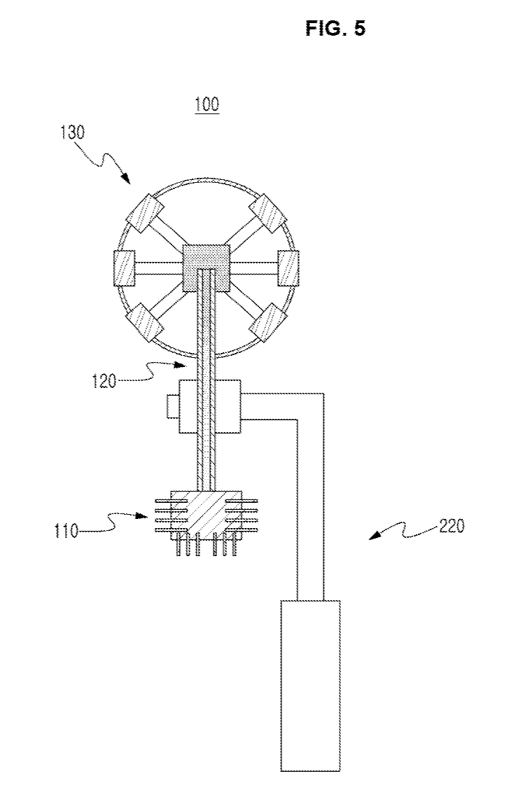

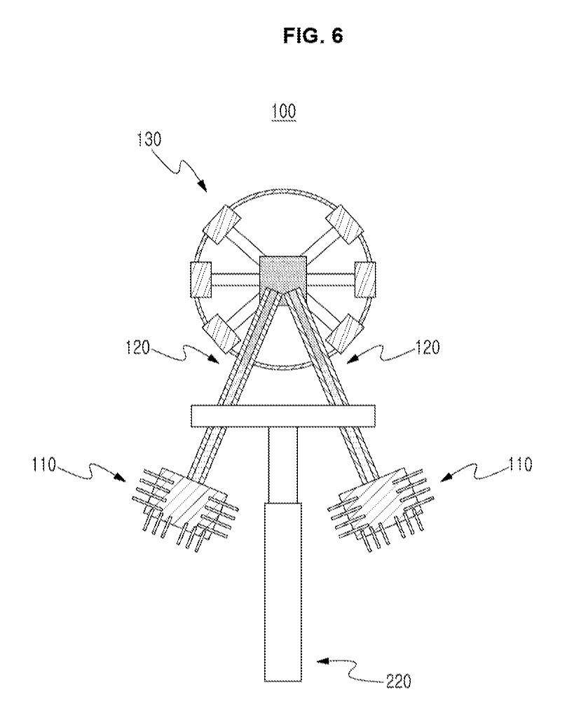

FIGS. 5 and 6 show application examples of a noiseless omnidirectional camera apparatus according to another embodiment of the inventive concept.

More specifically, FIG. 5 illustrates a balancing actuator 220 that maintains an upright state of the noiseless omnidirectional camera apparatus 100 including the single heat radiating structure 110. Further, FIG. 6 illustrates the balancing actuator 220 that maintains the upright state of the noiseless omnidirectional camera apparatus 100 including the plurality of heat radiating structures 110.

With reference to FIGS. 5 and 6, in the noiseless omnidirectional camera apparatus 100 according to another embodiment of the inventive concept, the heat radiating structure 110 may serve as a counterweight for the main body 130. The noiseless omnidirectional camera apparatus 100 may place the heat radiating structure 110 below the main body 130 to be spaced apart from the main body 130. Thus, a position of a center of gravity may be lowered such that the weight balance may be achieved for maintaining the main body 130 at a level state. Maintaining a camera at a level state may be a very important factor in the video filming.

The noiseless omnidirectional camera apparatus 100 according to another embodiment of the inventive concept may include the balancing actuator 220 coupled to the connector 120.

For example, according to another embodiment of the inventive concept, when the user moves while carrying the noiseless omnidirectional camera apparatus 100, or when the main body 130 rotates, the balancing actuator 220 may maintain the upright state of the camera apparatus 100 when the main body 130 moves or rotates around an axis. Specifically, the balancing actuator 220 may be a gimbal.

The balancing actuator 220 may be used for maintaining the camera at a level state and minimizing a shake in the video filming using the main body 130. In this connection, the balancing actuator 220 may actuate an object to pivot around the axis, and may be in a form of a tri-axis structure or a form that each axis has a motor.

In some embodiments, when the camera in the main body 130 is a medium or large camera, when the size and the weight of the main body 130 itself is large, or when a large number of cameras are included in the main body 130, a separate counter weight must be included to connect the balancing actuator 220. However, in the noiseless omnidirectional camera apparatus 100 according to another embodiment of the inventive concept, the heat radiating structure 110 may serve as the counter weight.

That is, with reference to FIGS. 5 and 6, the noiseless omnidirectional camera apparatus 100 according to another embodiment of the inventive concept may include the balancing actuator 220 that is connected to the connector 120 regardless of a number of the heat radiating structure 110. Then, the camera apparatus 100 may use the balancing actuator 220 to maintain the main body 130 at a level state, maintain the main body 130 at the upright state in the rotation, and minimize the shake thereof.

In addition, the noiseless omnidirectional camera apparatus 100 according to another embodiment of the inventive concept may use the heat radiating structure 110 as the counter weight via the connection thereof with the balancing actuator 220, such that the components and structure of the camera apparatus 100 may be minimized or simplified. Furthermore, the heats generated from the main body 130 may be dissipated or cooled, and the weight balance may be maintained such that the effect caused by the heat radiating structure 110, for example the noise and the vibration resulting from the heat sink, the fan, the thermo-electric element, the battery, and the like does not adversely affect the video quality.

Furthermore, an arrangement, a shape, and the like of the balancing actuator 220 shown in FIGS. 5 and 6 are not limited thereto.

According to an embodiment of the inventive concept, the main body including the plurality of cameras and the microphone, and the heat radiating structure that radiates the heats generated from the plurality of cameras may be formed to spaced apart from each other such that the generated heats of the main body may be dissipated and cooled without the noise and the vibration generated in the heat radiating structure affecting the video quality.

In addition, according to an embodiment of the inventive concept, the heat radiating structure including at least one of the heat sink, the fan, the thermo-electric element, and the battery may be formed to be separated from the main body such that the weight balance is achieved for maintaining the main body at a level state.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implementations, other embodiments, and equivalents to the claims are within the scope of the following claims.

What is claimed is:

1. A noiseless omnidirectional camera apparatus comprising:
a main body including a plurality of cameras for generating omnidirectional image data, a microphone for acquiring omnidirectional sound data, and a heat collecting module for collecting heats generated from the plurality of cameras;
a heat radiating structure spaced apart from the main body, wherein the heat radiating structure radiates the heats collected by the heat collecting module; and
a connector for connecting the main body and the heat radiating structure, wherein the connector transfers the heats collected by the heat collecting module to the heat radiating structure.

2. The noiseless omnidirectional camera apparatus of claim 1, wherein the heat radiating structure as a noise source or a vibration source is spaced from the main body including the microphone for acquiring ambient sound data, such that the camera apparatus generates noiseless video data.

3. The noiseless omnidirectional camera apparatus of claim 1, wherein the main body includes an image processing module for stitching the omnidirectional image data generated by the plurality of cameras to generate the video data.

4. The noiseless omnidirectional camera apparatus of claim 1, wherein the main body includes heat transfer modules for transferring, to the heat collecting module, respectively the heats generated from the plurality of cameras arranged at a predetermined interval.

5. The noiseless omnidirectional camera apparatus of claim 1, wherein the heat radiating structure is spaced apart from the main body, wherein the heat radiating structure includes at least one of a heat sink, a fan, a thermo-electric element, and a battery, wherein the heat radiating structure is further constructed for achieving a weight balance such that the main body is maintained at a level state.

6. The noiseless omnidirectional camera apparatus of claim 5, wherein the heat radiating structure includes a single heat radiating structure or a plurality of heat radiating structures.

7. The noiseless omnidirectional camera apparatus of claim 5, wherein the heat radiating structure uses the heat sink and the fan to dissipate the heats collected in the main body.

8. The noiseless omnidirectional camera apparatus of claim 5, wherein the heat radiating structure uses the heat sink and the thermo-electric element to cool the main body.

9. The noiseless omnidirectional camera apparatus of claim 1, wherein the connector is in a form of a heat pipe, and transfers the heats collected by the heat collecting module to the heat radiating structure.

10. The noiseless omnidirectional camera apparatus of claim 9, wherein the heat pipe includes:
a heat input portion for sucking the heats collected by the heat collecting module;
an insulation portion for transferring the collected heats; and
a heat output portion for discharging the collected heats to the heat radiating structure,
wherein the collected heats move in and along an inner space defined in the pipe and the pipe has a heat insulating coating on an outer face.

11. The noiseless omnidirectional camera apparatus of claim 1, further comprising a balancing actuator coupled to the connector,
wherein the balancing actuator allows the heat radiating structure to pivot around an axis such that the main body moves while being maintained at an upright state.
